(19) United States
(12) Patent Application Publication
(10) Pub. No.: US 2025/0072432 A1
(43) Pub. Date: Mar. 6, 2025

(54) BED BUG CONTROL COMPOSITION

(71) Applicant: Pouch Pac Innovations, LLC, Sarasota, FL (US)

(72) Inventors: R. Charles Murray, Sarasota, FL (US); John Harlin, Sarasota, FL (US)

(21) Appl. No.: 18/814,986

(22) Filed: Aug. 26, 2024

Related U.S. Application Data
(60) Provisional application No. 63/535,720, filed on Aug. 31, 2023.

(51) Int. Cl. A01N 65/22; A01N 25/04; A01N 65/28; A01P 7/04

(52) U.S. Cl. CPC A01N 65/22; A01N 25/04; A01N 65/28; A01P 7/04

(57) ABSTRACT

A bed bug control composition and method of controlling bed bug populations is disclosed. The bed bug control composition includes plant-based active ingredients and inert ingredients. The active ingredients include active ingredients including peppermint oil, clove oil, and rosemary oil. The inert ingredients include mineral oil, isopropyl myristate, isopropyl alcohol, oleic acid, and ethyl lactate.

### CROSS-REFERENCE TO RELATED APPLICATIONS

This application claims priority to U.S. Provisional Application No. 63/535,720 filed on Aug. 31, 2024, the contents of which are hereby incorporated by reference in its entirety.

### FIELD OF INVENTION

The present disclosure is directed to a bed bug control formulation. More particularly, the present disclosure is directed towards a non-toxic bed bug control (extermination) formulation that contains plant-based active ingredients.

### BACKGROUND OF THE INVENTION

Bed bugs are members of the genus Cimex that feed on blood, usually at night. Bed bugs often enter dwellings (including homes, hotels, and motels) in luggage, clothing, or other items, and typically live in places near the sleeping areas of humans, such as walls, mattresses, bed frames, and box springs. Bed bugs are one of the most difficult pest problems to eradicate quickly.

A number of insecticides have been proposed for killing bed bugs. These insecticides are effective in killing bedbugs but their toxicity towards non-targeted living organisms has been a major concern. Potent insecticides such as DDT (dichlorodiphenyltrichloroethane) to weaker insecticides such as pyrethroids (include the synthetic form cypermethrin) have been used to control the bedbug nuisance. However, these insecticides are not only hazardous to human health (e.g., neurotoxic and/or carcinogenic), but bed bugs have begun to develop resistance to the poison leading to reduced efficacy over time.

There is a need to develop a natural bed bug control composition that is highly effective in killing bed bugs and does not contaminate the atmosphere and human beings with harmful chemicals.

According to the disclosure, there is provided a natural non-toxic ingredient, plant-based composition to control (e.g., eradicate) beg bugs, as set forth in the appended claims.

### SUMMARY OF THE INVENTION

An object of the disclosure is to provide a safe, non-toxic (to mammals) bed bug control composition that is effective in killing bed bugs and that will not harm the environment.

In one aspect, there is disclosed a bed bug control composition including active and inert (or inactive) ingredients. The active ingredients include peppermint oil, clove oil, and rosemary oil. The inert ingredients include mineral oil, isopropyl myristate, isopropyl alcohol, oleic acid, and ethyl lactate. The provision of plant-based active ingredients in the form of peppermint oil, clove oil, and rosemary oil provides a non-toxic poison that is safe to humans and effective in eradicating bed bug infestations.

The disclosed composition uses plant-based active ingredients and synergistic compounds that target the bed bugs differently from traditional poisons, overcoming their resistance mechanisms. The bed bug control composition has been shown by extensive testing to not only kill bed bugs effectively but also lasts longer than other leading brands, maintaining its killing efficacy for up to 48 hours, with 80% of the formula remaining effective after 96 hours.

Additional features and advantages of the bed bug control formulation described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein and together with the description serve to explain the principles and operations of the claimed subject matter.

### BRIEF DESCRIPTION OF THE DRAWINGS

FIG. 1 shows the duration test results for the bed bug control formulation disclosed herein;

FIG. 2 shows a graph representing duration test results between the bed bug formulation and a comparative pyrethroid product;

FIG. 3 shows a line graph summarizing the evaporation test results between the disclosed bed bug formulation and the commercially available cypermethrin product.

### DETAILED DESCRIPTION OF THE EMBODIMENTS

In one aspect, there is disclosed herein a bed bug control formulation formed from plant-based active ingredients.

### Example

In one aspect, the bed bug control formulation may include:

| ACTIVE | | PERCENT |
|---|---|---|
| INGREDIENTS | PERCENTAGE | RANGE |
| Peppermint Oil | 2 | PLUS-MINUS |
| | | 1.5% |
| Clove Oil | 1.5 | PLUS-MINUS |
| | | 1% |
| Rosemary Oil | 1 | PLUS-MINUS |
| | | 0.5% |
| INERT | | |
| INGREDIENTS | | |
| Mineral Oil | 49 | PLUS-MINUS |
| | | 20% |
| Isopropyl | 23 | PLUS-MINUS |
| Myristate | | 18% |
| Isopropyl | 14.3 | PLUS-MINUS |
| Alcohol | | 7% |
| Oleic Acid | 9 | PLUS-MINUS |
| | | 6% |
| Ethyl Lactate | 0.2 | PLUS-MINUS |
| | | 0.1% |
| Lauric Acid | 0.001 | PLUS-MINUS |
| (optional) | | 0.0005% |

In the above formula, the CP=3.95+/−10%, and/or the NTU=0.0.

As specified above, the bed bug control composition includes active ingredients and inert ingredients. The active ingredients may include peppermint oil, clove oil, rosemary oil. The inert ingredients may include mineral oil, isopropyl myristate, isopropyl alcohol, oleic acid, and ethyl lactate. Lauric acid may optionally be present as an inert/inactive ingredient.

The peppermint oil may be present in an amount of from 0.5% to 3.5% by weight, particularly from 1.5% to 2.5% by weight. The clove oil (e.g., clove stem oil) may be present in an amount of 0.5% to 2.5% by weight, particularly from 1% to 2% by weight. The rosemary oil may be present in an amount of 0.5% to 1.5% by weight, particularly from 0.75% to 1.25% by weight. The mineral oil (e.g., white mineral oil) may be present in an amount of from 29% to 69% by weight, particularly from 40% to 60% by weight, more particularly from 45% to 55% by weight. The isopropyl myristate may be present in an amount of from 5% to 41% by weight, particularly from 15% to 31% by weight, more particularly from 20% to 26% by weight. The isopropyl alcohol (e.g., 99% isopropanol) may be present in an amount from 7% to 21% by weight, particularly from 10% to 18% by weight. The oleic acid (e.g., organic oleic acid 75%) may be present in an amount of from 3% to 15% by weight, particularly from 6% to 12% by weight. The ethyl lactate may be present in an amount from 0.1% to 0.3% by weight, particularly from 0.15% to 0.25% by weight, more specifically about 0.2% (0.19%-0.21%) by weight. The lauric acid may optionally be present in an amount from 0.0001% to 0.01% by weight, particularly from 0.0005% to 0.0015% by weight, more particularly about 0.001% (0.0009%-0.0011%) by weight. The weight percentages are based on a total weight of the composition.

The bed bug control formulation may be prepared into a liquid, such as a clear liquid, for treatment of the affected area.

### Testing and Results

The duration and efficacy of eradicating or exterminating bed bugs of the above-described composition was tested against a comparative example comprising a leading pyrethroid (cypermethrin) product in a controlled environment.

Live bed bugs were exposed in a controlled laboratory environment under rigorous conditions to allow for rapid evaporation to test both “kill on contact” or “kill rate” as well as duration of effectiveness for 24 hours in open containers exposed to low relative humidity of 40% and room temperatures of 22 C (72 F).

Clear liquids from the bed bug control composition of the present disclosure and a leading bed bug spray using a Pyrethroid (Cypermethrin) were used to coat the base of 250 ml beakers with 0.3 ml of the sprays. The base diameter of the beaker is 5.3 cm (2.09 inches). The thin film coating the base of the beaker was dispersed at 0.011 ml/cm2 for each spray. Three repeats were performed for each test with static results.

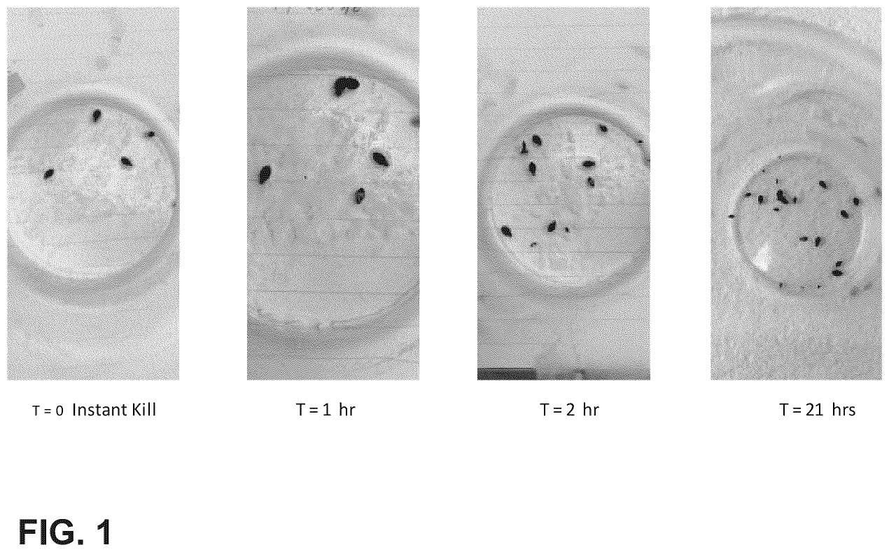

FIG. 1 shows the duration test results for the bed bug control formulation disclosed herein. The formulation is a clear liquid (0.011 ml/cm²). At T=0 (immediate exposure to the formulation), the bed bugs died instantly. At T=1 hr, after 1 hour with drying of the formulation, two additional bed bugs were added, and the bed bugs died within two (2) minutes. At T=2 hr, after 2 hours with drying of the formulation, two additional adult bed bugs and infant bed bugs were added, and the infant bed bugs died immediately and the adult bed bugs dies within 2 minutes of exposure. At T=21 hr, after 21 hours of drying of the formulation, ten additional adult bed bugs and infants were added and died within 17 minutes of exposure.

In another test, comparative (side by side) test were performed with 0.011/cm² of a leading commercially available cypermethrin product and the bed bug control formulation disclosed herein. The test measured and compared the kill rate of bed bugs over a period of four (4) hours, testing at T=0, T=1.5 hr, and T=4 hr. The results are shown in Table 1:

TABLE 1

| | Bed Bug | Comparative |
|---|---|---|
| | Control | Cypermethrin |
| Duration | Formulation | Product |
| T = 0 | 100% instant kill | 100% instant kill |
| T = 1.5 hr | 100% instant kill | 80% instant kill, |
| | | subsequently 100% |
| | | kill after 10 minutes |
| T = 4 hr | 100% kill within 1 minute | 0% kill |

Table 1 demonstrates that the bed bug control formulation is superior with respect to kill rate over a 4 hour duration as compared to a leading commercially available cypermethrin product.

A similar test was conducted at the Department of Biological Sciences, Florida Atlantic University (FAU). However, the FAU testing used filter paper at the base of the container where 0.03 ml of the liquids was placed in the center of 10 cm plastic cups. The filter paper was treated with the clear liquids of both a commercially available cypermethrin product and the bed bug control formulation. The containers were left open exposed to evaporation to determine the efficacy after various time periods and potential evaporation.

Bed bugs were placed on the treated area. The reactions of the bed bugs to these pesticides were recorded for a period of 48 hours. At least three repeats were performed for each pesticide. For duration, the unlidded (exposed) containers were open to 24° C. temperature for 24 hours, then the bed bugs were placed on each of the treated area.

Instant response tests demonstrated that all 22 bed bugs introduced to the bed bug control formulation were paralyzed 5 minutes after contact with the pesticide. They remained dead after 24 hours examination.

For the cypermethrin product, 15 of 18 bed bugs were paralyzed after 5 minutes, but they were not dead. Movement was seen in some of these bugs after 24 hours.

The results of the test are shown in Table 2:

TABLE 2

| | Number of bed | Number of bed bugs at time | | |
|---|---|---|---|---|
| | bugs before | after contact with pesticide | | |
| | contact with | 5 minutes | 20 minutes | 24 hours |
| Pesticide | pesticide | paralyzed | appeared dead | # alive |
| Disclosed | 22 | 22 | 22 | 0 |
| Formulation | | | | |
| Cypermethrin | 18 | 15 | 18 | 2 |
| Product | | | | |

Table 2 demonstrates that the disclosed bed bug control formulation not only has a higher kill rate than a leading commercially available cypermethrin product, but also has greater longevity or duration.

For duration testing, the pesticide-soaked containers were left open for 24 hours, then bed bugs were introduced.

Three hours later, 7 of the 38 bed bugs (only 18%) were alive after treatment from the disclosed bed bug formulation. In comparison, 14 of 23 of bed bugs (61%) were alive after treatment of the cypermethrin product. Twenty-four hours later, none of the bed bugs were alive after treatment with the bed bug formulation, whereas all of the remaining 14 bed bugs were alive after treatment with the cypermethrin product treatment.

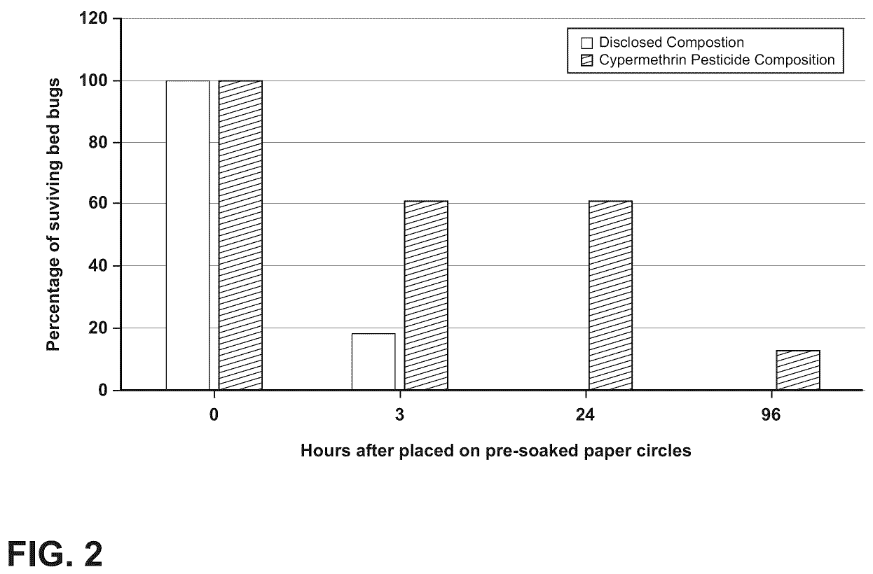

FIG. 2 shows a graph representing the percentage of bed bugs survived in contact with treated areas soaked with pesticide 24 hours prior. None of the bed bugs survived the treatment by the disclosed bed bug formulation after 48 hours (24 hour contact time). In comparison, the commercially available cypermethrin product lost most of its potency 24 hours after use.

### Evaporation Test.

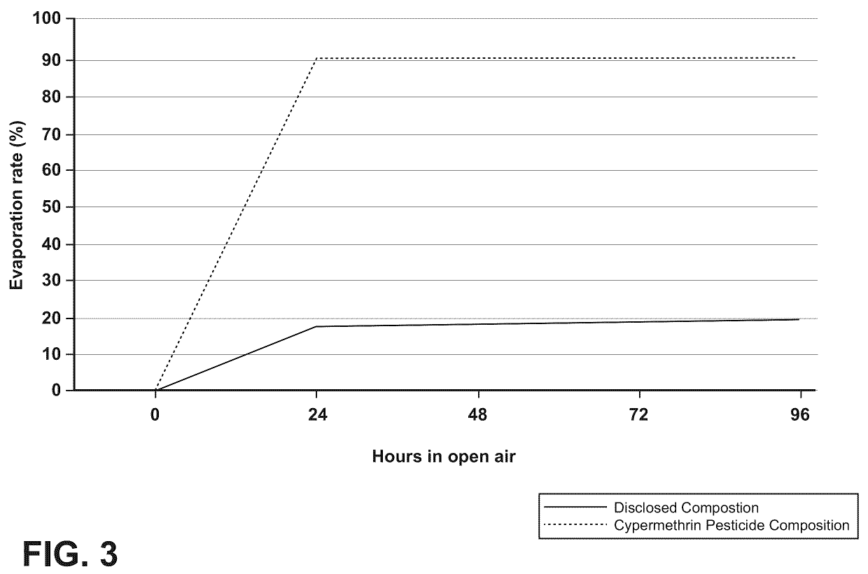

A weighing boat and a glass fiber paper circle were weighed, followed by adding 0.3 ml of either the disclosed bed bug formulation or a commercially available cypermethrin product, and weighed again. The treated areas (pesticide-soaked paper circles) were left open to air (ambient environment) for 24 hours. Eight repeats were tested for each pesticide. The boats with pesticide-soaked paper circles were left open in the air for 24 hours. The boats were weighed. Within 24 hours, 91% of the cypermethrin product was evaporated, whereas only 17.6% of the disclosed bed bug formulation was evaporated. By the 96th hour in the open air, 91.1% of the cypermethrin product was evaporated, whereas only 19.2% of the disclosed bed bug formulation was evaporated, which suggests that within 24 hours, almost all applied the cypermethrin product was evaporated while over 80% of “the disclosed bed bug formulation still remained after 96 hours. FIG. 3 illustrates a line graph showing the evaporation test results between the disclosed bed bug formulation and the commercially available cypermethrin product. The cypermethrin pesticide quickly evaporated on glass fiber paper circles. By comparison, the disclosed bed bug formulation did not evaporate for days, during which time the pesticide remained active.

The test results demonstrate that the bed bug control composition provides a safe, non-toxic insecticide for exterminating bed bugs. The formulation demonstrates both a higher kill rate and much longer efficacy at killing bed bugs permanently than comparative cypermethrin pesticides. The formulation is 100% effective after 24 hours while the leading pyrethroid poison has zero efficacy in the comparative testing at that longevity. Further, the bed bug formulation has a much higher kill rate than pyrethroids as documented in Tables 1 and 2. The formulation may be added to a pest control fogger or another spray device to treat the bed bug infested area with near instant effectiveness. For example, a bedroom can be treated in 5 minutes with cracks and crevices serviced. Further, the formulation is non-toxic with plant based active ingredients.

Accordingly, the disclosed bed bug control composition has numerous advantages including: eco-friendly and safe plant-based formula that kills on contact and provides long-lasting protection, wherein the formula is made from natural ingredients that are scent-free and stain-free; the formula demonstrates 100% efficacy that kills all stages of growth (adult bed bugs and nymphs) and bed bugs that are resistant to traditional pesticides; non-toxic formula is safe to in homes, hotels, motels, hospitals and schools and other places where bed bugs breed, and may be applied (e.g., sprayed) onto furniture, mattresses and floors and wall boards and works on contact without requiring evacuation of the treated area; the formula does not evaporate readily, extending the protection period for up to 4 days.

From the above, there is disclosed a bed bug control composition that includes active ingredients and inert ingredients. The active ingredients include peppermint oil, clove oil, and rosemary oil. The inert ingredients include mineral oil, isopropyl myristate, isopropyl alcohol, oleic acid, and ethyl lactate. Optionally, lauric acid may be present. The composition may be prepared in the form of a clear liquid that is sprayed (e.g., via a spray bottle or fogger) onto target areas.

According to another aspect, there is disclosed bed bug control spray formulation. The formulation includes active ingredients consisting of peppermint oil, clove oil, and rosemary oil, and inert ingredients consisting of mineral oil, isopropyl myristate, isopropyl alcohol, oleic acid, and ethyl lactate.

According to yet another aspect, there is disclosed a method of controlling bed bugs. The method includes applying a spray composition to an infested area, the spray composition including active ingredients and inert ingredients. The active ingredients include peppermint oil, clove oil, and rosemary oil. The inert ingredients including mineral oil, isopropyl myristate, isopropyl alcohol, oleic acid, and ethyl lactate.

Although the present disclosure has been described with reference to a bed bug control composition, it will be appreciated that formulation may also be used to control (exterminate) fleas and mites.

Even though the present disclosure has been described in detail with reference to specific examples, it will be appreciated that the various modifications and changes can be made to these examples without departing from the scope of the present disclosure as set forth in the claims. It is anticipated and intended that future developments will occur in the technologies discussed herein, and that the disclosed product, composition and/or method will be incorporated into such future developments. Thus, the specification and the drawings are to be regarded as an illustrative thought instead of merely restrictive thought.

It should be understood that references to a single element are not necessarily so limited and may include one or more of such element. Further, all numbers expressing dimensions, ratios and the like, used in the specification and claims, are to be understood to encompass tolerances and other deviations as represented by the term “about” or “approximately.”

The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed is:

1. A bed bug control composition, comprising:
active ingredients including peppermint oil, clove oil, and rosemary oil; and
inert ingredients including mineral oil, isopropyl myristate, isopropyl alcohol, oleic acid, and ethyl lactate.

2. The bed bug control composition of claim 1, wherein the peppermint oil is present in an amount of from 0.5% to 3.5% by weight, the clove oil is present in an amount of 0.5% to 2.5% by weight, and the rosemary oil is present in an amount of 0.5% to 1.5% by weight.

3. The bed bug control composition of claim 2, wherein the amount of peppermint oil is from 1.5% to 2.5% by weight.

4. The bed bug control composition of claim 2, wherein the amount of clove oil is from 1% to 2% by weight.

5. The bed bug control composition of claim 2, wherein the amount of rosemary oil is from 0.75% to 1.25% by weight.

6. The bed bug control composition of claim 1, wherein the mineral oil is present in an amount of from 29% to 69% by weight, the isopropyl myristate is present in an amount of from 5% to 41% by weight, the isopropyl alcohol is present in an amount from 7% to 21% by weight, the oleic acid is present in an amount of from 3% to 15% by weight, and the ethyl lactate is present in an amount from 0.1% to 0.3% by weight.

7. The bed bug control composition of claim 6, wherein at least one of:
the amount of mineral oil is from 40% to 60% by weight;
the amount of isopropyl myristate is from 15% to 31% by weight;
the amount of isopropyl alcohol is from 10% to 18% by weight;
the amount of oleic acid is from 6% to 12% by weight;
the amount of ethyl lactate is from 0.15% to 0.25% by weight.

8. The bed bug control composition of claim 6, wherein the amount of mineral oil is from 45% to 55% by weight.

9. The bed bug control composition of claim 6, wherein the amount of isopropyl myristate is from 20% to 26% by weight.

10. The bed bug control composition of claim 1, wherein the inert ingredients further include lauric acid.

11. The bed bug control composition of claim 10, wherein the lauric acid is present in an amount from 0.0001% to 0.01% by weight.

12. The bed bug control composition of claim 1, in the form of a clear liquid.

13. A spray bottle, comprising the bed bug control composition as claimed in claim 1.

14. A bed bug control spray formulation, comprising:
active ingredients consisting of peppermint oil, clove oil, and rosemary oil;
inert ingredients consisting of mineral oil, isopropyl myristate, isopropyl alcohol, oleic acid, and ethyl lactate.

15. The bed bug control spray formulation of claim 14, wherein the peppermint oil is present in an amount of from 0.5% to 3.5% by weight, the clove oil is present in an amount of 0.5% to 2.5% by weight, and the rosemary oil is present in an amount of 0.5% to 1.5% by weight.

16. The bed bug control spray formulation of claim 14, wherein the mineral oil is present in an amount of from 29% to 69% by weight, the isopropyl myristate is present in an amount of from 5% to 41% by weight, the isopropyl alcohol is present in an amount from 7% to 21% by weight, the oleic acid is present in an amount of from 3% to 15% by weight, and the ethyl lactate is present in an amount from 0.1% to 0.3% by weight.

17. A method of controlling bed bugs, comprising:
applying a spray composition to an infested area, the spray composition including active ingredients and inert ingredients;
the active ingredients including peppermint oil, clove oil, and rosemary oil; and
the inert ingredients including mineral oil, isopropyl myristate, isopropyl alcohol, oleic acid, and ethyl lactate.

18. The method of claim 17, wherein the peppermint oil is present in an amount of from 0.5% to 3.5% by weight, the clove oil is present in an amount of 0.5% to 2.5% by weight, and the rosemary oil is present in an amount of 0.5% to 1.5% by weight.

19. The method of claim 17, wherein the mineral oil is present in an amount of from 29% to 69% by weight, the isopropyl myristate is present in an amount of from 5% to 41% by weight, the isopropyl alcohol is present in an amount from 7% to 21% by weight, the oleic acid is present in an amount of from 3% to 15% by weight, and the ethyl lactate is present in an amount from 0.1% to 0.3% by weight.

20. The method claim 17, wherein the inert ingredients further include lauric acid.
